(19) United States
(12) Patent Application Publication
(10) Pub. No.: US 2007/0274691 A1
(43) Pub. Date: Nov. 29, 2007

(54) Data reproducing apparatus, data presentation method and data presentation system

(75) Inventor: Norikatsu Chiba, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/701,499

(22) Filed: Feb. 2, 2007

(30) Foreign Application Priority Data
Mar. 29, 2006 (JP) P2006-091101

(51) Int. Cl. H04N 5/00

(52) U.S. Cl. 386/125

(57) ABSTRACT

According to one embodiment, a data reproducing apparatus generates content display data to display a content table in which a media identification code specific to a recording medium and a content code identifiable a content recorded on the recording medium are associated. Besides, the data reproducing apparatus controls so that a communication device transmits transmission request data showing a transmission request relating to the media identification code and the content code to external, and controls so that content display data is to be generated based on received data received by the communication device with corresponding to the transmission request data transmitted by the communication device.

### CROSS-REFERENCE TO RELATED APPLICATIONS

This application is based upon and claims the benefit of priority from Japanese Patent Application No. 2006-91101, filed Mar. 29, 2006, the entire contents of which are incorporated herein by reference.

### BACKGROUND

1. Field

One embodiment of the invention relates to a data reproducing apparatus such as a DVD player, a DVD recorder, capable of using a removable medium, a data presentation method using the data reproducing apparatus, and a data presentation system having the data reproducing apparatus.

2. Description of the Related Art

Conventionally, there is a data reproducing apparatus capable of reproducing video and sound by reading digital data recorded on a recording medium (including a data recording/reproducing apparatus capable of recording video and sound as digital data). As an apparatus of this kind, a DVD player having a reproducing function reading digital data recorded on a removable medium and reproducing video and sound by using the removable medium such as a DVD (digital versatile disk), and a DVD recorder having a recording function of digital data for the removable medium in addition to the reproducing function become widely used. Among them, some DVD recorders house a hard disk drive (hereinafter, referred to as an “HDD”) and are capable of recording digital data on the HDD.

This kind of DVD recorder is utilized in a procedure in which a recording is performed by recording the digital data of video and sound of, for example, a television broadcasting on the HDD, and contents are included in the DVD by copying (make a dub) the digital data recorded on the HDD to the DVD.

However, there is a case when it becomes difficult for a user to accurately grasp what kind of contents are included in which DVD in accordance with an increasing of the number of DVDs including the contents. Consequently, there was a problem that trouble and time are required for the user to reproduce a desired content if the number of recording media including the contents increases in the conventional data reproducing apparatus such as the DVD recorder and the DVD player.

Conventionally, for example, there is an art relating to a recording/reproducing system composed of an optical disk in which disk identification data specific to a disk is provided in a visible manner from external and a recording/reproducing apparatus (for example, refer to Japanese Patent Publication (KOKAI) No. 2003-173541, hereinafter referred to as “Patent Document 1”) relating to the problem as stated above. In this recording/reproducing system, the recording/reproducing apparatus includes a storage device in which identification data and matter data of contents are stored in association with the disk identification data. Consequently, in this recording/reproducing apparatus, a user can search a recording medium including a desired content by making use of a search function in which the identification data and the matter data of the contents are searched based on the disk identification data.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a configuration of a data presentation system including data recording/reproducing apparatuses according to a first embodiment of the present invention;

FIG. 2 is an exemplary plan view showing a configuration of an example of an optical disk;

FIG. 3 is an exemplary view showing an example of a content data list;

FIG. 4 is an exemplary view showing an example of a content data table stored in a nonvolatile memory device;

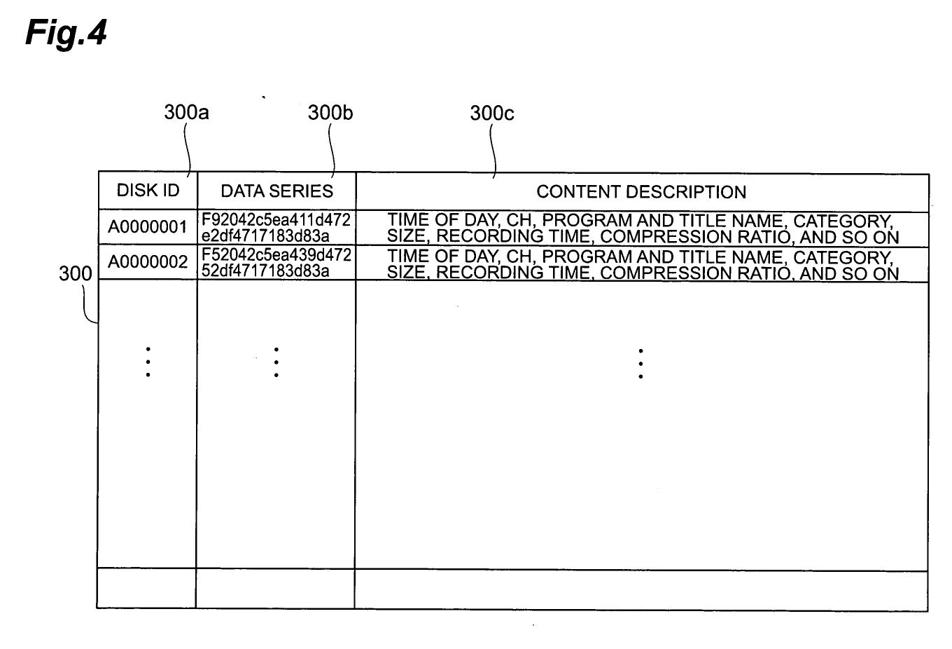

FIG. 5 is an exemplary view showing an example of an apparatus list table stored in the nonvolatile memory device;

FIG. 6 is an exemplary block diagram showing a configuration of a data presentation system including data recording/reproducing apparatuses according to a second embodiment of the present invention;

FIG. 7 is an exemplary view showing an example of a reproduction preparation navigation screen;

FIG. 8 is an exemplary flowchart showing an operation procedure of a reproduction preparation process;

FIG. 9 is an exemplary flowchart showing an operation procedure of an immediate update process;

FIG. 10 is an exemplary flowchart showing an operation procedure of a later update process;

FIG. 11 is an exemplary flowchart showing an operation procedure of an other apparatus priority process;

FIG. 12 is an exemplary flowchart showing an operation procedure of a transmission/reception checking process; and

FIG. 13 is an exemplary sequence chart showing an operation sequence of a data transmission/reception performed at the two data rerecording/reproducing apparatuses composing the data presentation system.

### DETAILED DESCRIPTION

Various embodiments according to the invention will be described hereinafter with reference to the accompanying drawings. In general, according to one embodiment of the invention, a data reproducing apparatus generates content display data to display a content table in which a media identification code specific to a recording medium and a content code identifiable a content recorded on the recording medium are associated. Besides, the data reproducing apparatus controls so that a communication device transmits transmission request data showing a transmission request relating to the media identification code and the content code to external, and controls so that content display data is to be generated based on received data received by the communication device with corresponding to the transmission request data transmitted by the communication device.

### First Embodiment

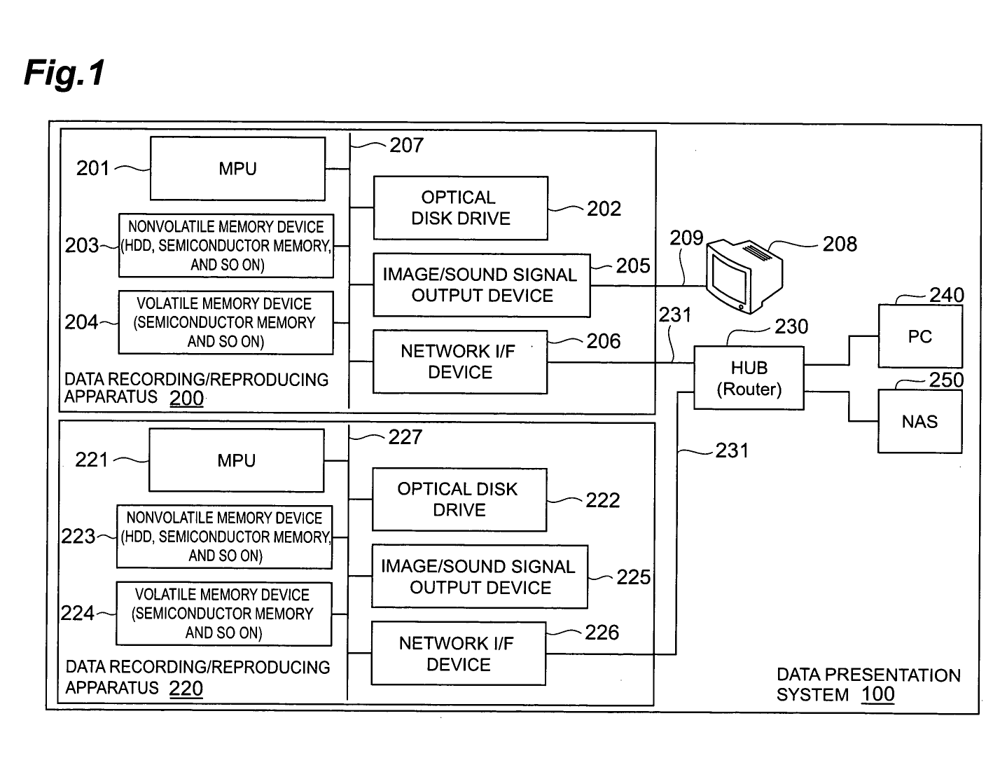

FIG. 1 is a block diagram showing a configuration of a data presentation system 100 including data recording/reproducing apparatuses 200, 220 according to a first embodiment of the present invention. As shown in FIG. 1, the data presentation system 100 has the data recording/reproducing apparatus 200, the data recording/reproducing apparatus 220, a PC (Personal Computer) 240, and a NAS (Network Attached Storage) 250. In the data presentation system 100, the data recording/reproducing apparatuses 200, 220, the PC 240, and the NAS 250 are connected via a HUB 230 (a router can be used instead of the HUB) and communication lines 231 (communication line 231 may be either wired or wireless) to thereby form a wired or wireless LAN (Local Area Network).

The data recording/reproducing apparatus 200 is able to use a later-described optical disk 110 such as a DVD-R, a DVD-RW, and a DVD-RAM as a removable medium. The data recording/reproducing apparatus 200 is a DVD recorder having a reproducing function reproducing contents included in the optical disk 110, and a recording function recording the contents on the optical disk 110.

This data recording/reproducing apparatus 200 has an MPU (Micro Processing Unit) 201, an optical disk drive 202, and a nonvolatile memory device 203. Besides, the data recording/reproducing apparatus 200 has a volatile memory device 204, an image/sound signal output device 205, and a network interface (I/F) device 206. Incidentally, respective components from the MPU 201 to the network I/F device 206 are connected with each other by a bus 207.

The MPU 201 is started up according to a boot program loaded from the nonvolatile memory device 203 to the volatile memory device 204. Besides, the MPU 201 controls a system initialization and a system termination according to a player program loaded from the nonvolatile memory device 203 to the volatile memory device 204, and at the same time, it is activated according to a later-described reproduction preparation program to execute a reproduction preparation process which is a characteristic of the present invention.

The optical disk drive 202 has functions as a reading device in the present invention reading digital data recorded on the optical disk 110 mounted on a not-shown disk tray and outputting a reproduction signal, and as a recording device in the present invention recording the digital data on the optical disk 110.

The nonvolatile memory device 203 is composed of an HDD (Hard Disk Drive) and a nonvolatile semiconductor memory such as a flash memory. The HDD records video and sound of a television broadcasting and so on, on a rapidly spinning magnetic disk as digital data, besides, reads the recorded digital data, and outputs the reproduction signal. This HDD has functions as a content table storage device and an apparatus identification code storage device in the present invention because a later-described content table 300 and apparatus list table 310 are stored therein. In the semiconductor memory, programs such as the boot program, the player program and the reproduction preparation program executed by the MPU 201 are stored. The volatile memory device 204 has a volatile semiconductor memory such as a DRAM. In the volatile memory device 204, data and programs used when the MPU 201 is activated are stored.

The image/sound signal output device 205 is connected to an image/sound output device 208 by a connection cord 209. The image/sound signal output device 205 inputs the reproduction signal outputted from the optical disk drive 202 and the reproduction signal outputted from the HDD of the nonvolatile memory device 203. Besides, the image/sound signal output device 205 generates video data and sound data by performing a process such as a decoding to the inputted reproduction signal, and outputs the generated video data and sound data to the image/sound output device 208 via the connection cord 209.

The network I/F device 206 is a communication device in the present invention, and has a communication terminal of the communication line 231. Besides, the network I/F device 206 is activated according to a control of the MPU 201, and performs a transmission/reception of data between the data recording/reproducing apparatus 220, the PC 240, and the NAS 250 when the communication line 231 is connected to the communication terminal.

Incidentally, the image/sound output device 208 is a television including a display device such as a liquid crystal display device and a CRT displaying videos reproduced by the data recording/reproducing apparatus 200, and a speaker outputting the reproduced sound.

The data recording/reproducing apparatus 220 has an MPU 221, an optical disk drive 222, a nonvolatile memory device 223, a volatile memory device 224, an image/sound signal output device 225, and a network I/F device 226. These MPU 221 to network I/F device 226 are connected with each other by a bus 227, and respectively have equivalent constitutions and functions as the MPU 201 to network I/F device 206 composing the above-stated data recording/reproducing apparatus 200.

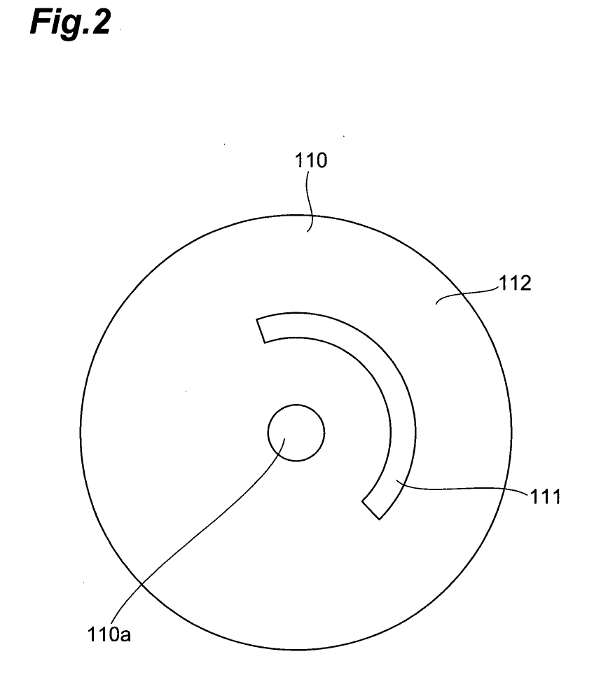

The optical disk 110 has a hole 111a, a burst cutting area (hereinafter referred to as a BCA) 111, and a recordable area 112 as shown in FIG. 2. A disk ID (media identification code) specific to the optical disk 110 is recorded at the BCA 111. Digital data can be recorded at the recordable area 112. Besides, a hash value (content code) specific to a content, generated by each included content and showing the content uniquely is recorded at the recordable area 112 when the contents are included in the optical disk 110. The hash value is generated by the MPU 201 according to a predetermined hash function (for example, MD5, SHAL, and so on).

The content table 300 has a disk ID area 300a in which the disk IDs are stored, a hash value area 300b in which the hash values are stored, and a contents specifying data area 300c in which contents specifying data to concretely specify the contents included in the optical disk 110 such as a recorded date and time, and a title of the contents are stored. In the content table 300, the disk ID in the disk ID area 300a and the hash value in the hash value area 300b are stored in association to store a correspondence between the optical disk 110 and the contents included in the optical disk 110. Consequently, the data recording/reproducing apparatus 200 manages which contents are included in the optical disk 110 by the disk ID and the hash value in this content table 300. Incidentally, the hash value stored in the hash value area 300b corresponds to the hash value recorded in the optical disk 110.

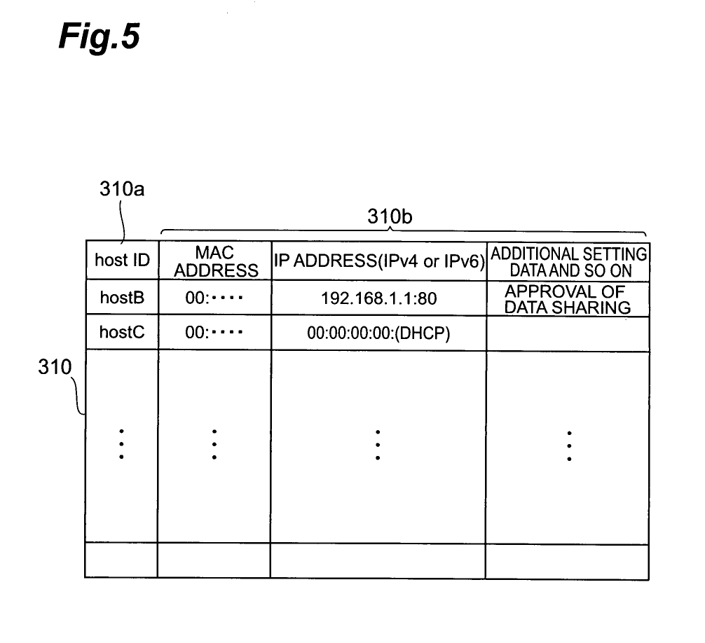

The apparatus list table 310 has an apparatus ID area 310a in which apparatus IDs (apparatus identification code) specific to the data recording/reproducing apparatuses 200, 220 composing the data presentation system 100 are stored, and a destination area 310b in which data to specify destinations of the data recording/reproducing apparatuses 200, 220 on the network (LAN) are stored, as shown in FIG. 5. In the destination area 310b, data (destination data) such as a MAC address, an IP address, additional setting data are stored.

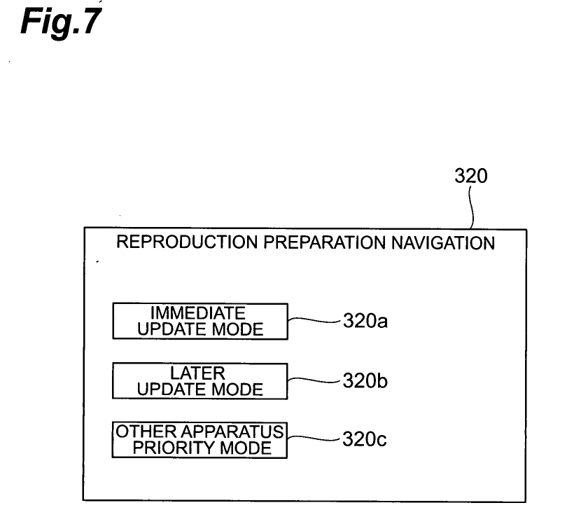

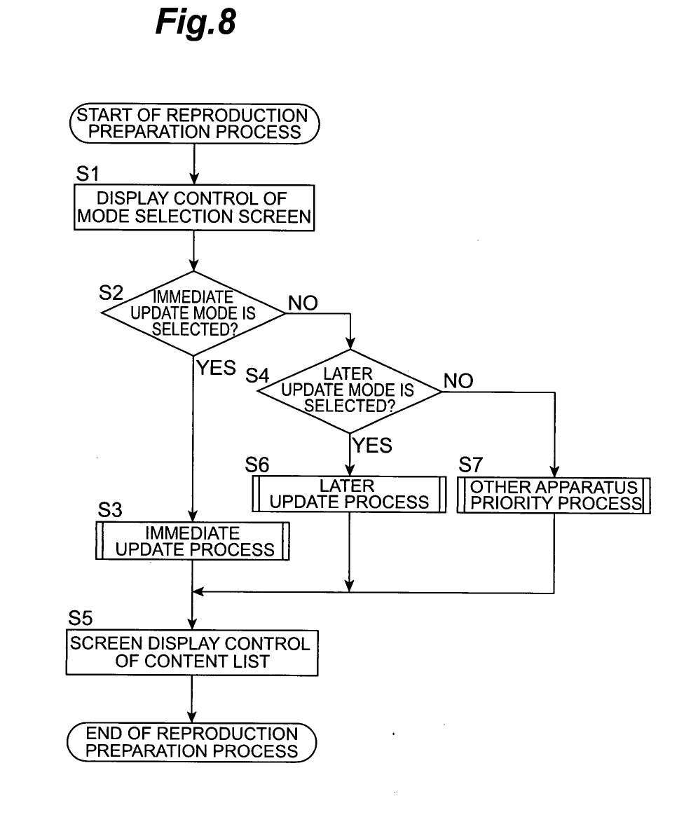

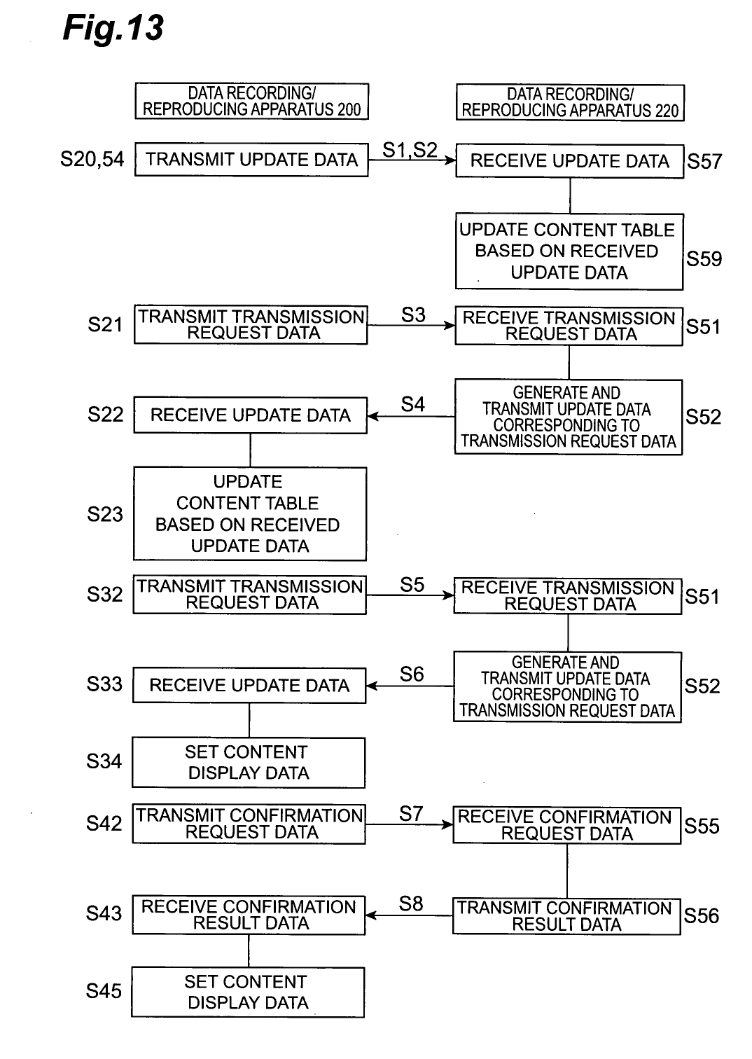

Next, operations of the data presentation system 100 having the above-stated configuration are described with reference to FIG. 7, flowcharts shown in FIG. 8 to FIG. 12, and a sequence chart shown in FIG. 13. In the following description, the case is assumed when a user searches a content desired to be reproduced from among the contents included in the optical disk 110 by using the data recording/reproducing apparatus 200. In this case, the data recording/reproducing apparatus 200 displays a later-described content list 311 on the image/sound output device 208 so that the user can search the content desired to be reproduced quickly. Herewith, a presentation of useful data for the user to search the content is performed. The process in which the data recording/reproducing apparatus 200 displays the content list 311 on the image/sound output device 208 before the reproduction of the content is called as the reproduction preparation process. Besides, the other apparatus shown in the following assumes the data recording/reproducing apparatus 220.

At first, the user specifies the reproduction preparation process by operating a not-shown remote control with reference to a display device of the image/sound output device 208 after housing the optical disk 110 in the disk tray when the user searches the contents desired to be reproduced from among the contents included in the optical disk 110. Subsequently, the MPU 201 starts up the reproduction preparation program in the data recording/reproducing apparatus 200. The reproduction preparation program is executed in accordance with the flowchart shown in FIG. 8.

When the execution of the reproduction preparation program is started, the MPU 201 advances the process to the block 1, and displays a reproduction preparation navigation screen 320 shown in FIG. 7 on the image/sound output device 208. This reproduction preparation navigation screen 320 is a screen to make the user select a desired reproduction preparation mode from among three reproduction preparation modes of an immediate update mode, a later update mode, and an other apparatus priority mode as shown in FIG. 7. The user performs the remote control operation by placing a cursor on a desired mode display portion from among the mode display portions 320a, 320b, and 320c while operating the not-shown remote control, and is enabled to select the desired reproduction preparation mode.

The MPU 201 judges the reproduction preparation mode selected by the user at the blocks 2, 4, and the process is branched based on judged results at the blocks 2, 4. Namely, the MPU 201 judges whether the user selects the immediate update mode or not at the block 2, it proceeds to the block 3 when the immediate update mode is selected, and otherwise, it proceeds to the block 4. Besides, the MPU 201 judges whether the user selects the later update mode or not at the block 4. Here, the MPU 201 proceeds to the block 6 when the later update mode is selected, and otherwise (when the other apparatus priority mode is selected), it proceeds to the block 7.

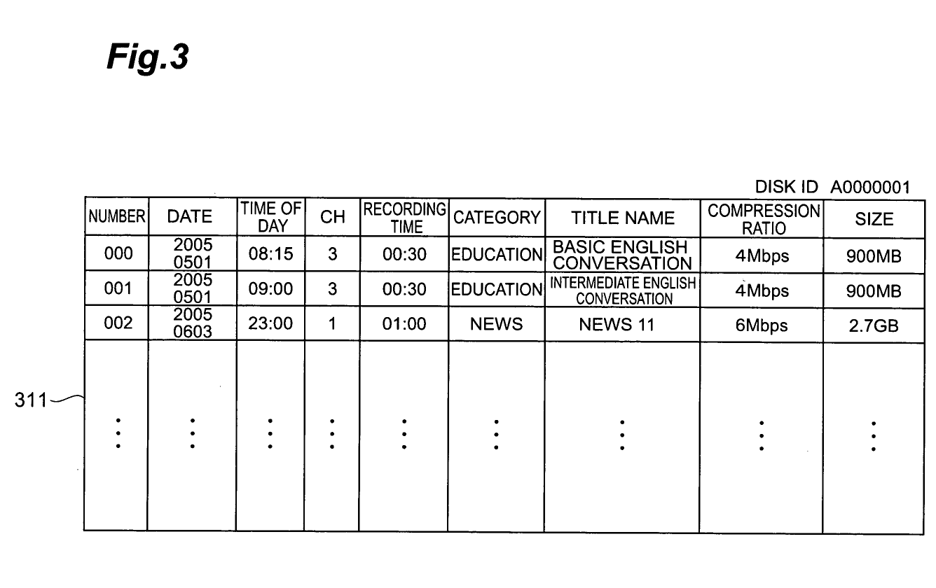

Besides, after the MPU 201 executes the block 3, 6 or 7, it proceeds to the block 5 to perform a screen display control of the content list, and displays the content list 311 on the image/sound output device 208 by using content display data generated at either of later-described blocks 24, 34, and 47. The content list 311 is edited by each optical disk 110 as shown in FIG. 3, and it is a list in which data relating to the included contents (recorded date, recorded time of day, channel, recording time, category, title name, compression ratio, and size) are list displayed. Consequently, the user can grasp the included contents by referring to the content list 311 to search the content desired to be reproduced.

The MPU 201 executes the immediate update process when it proceeds to the block 3. This immediate update process is the process in which the content table 300 is updated based on the digital data read from the optical disk 110 including the contents immediately after it is read, and the content list 311 is displayed based on the above.

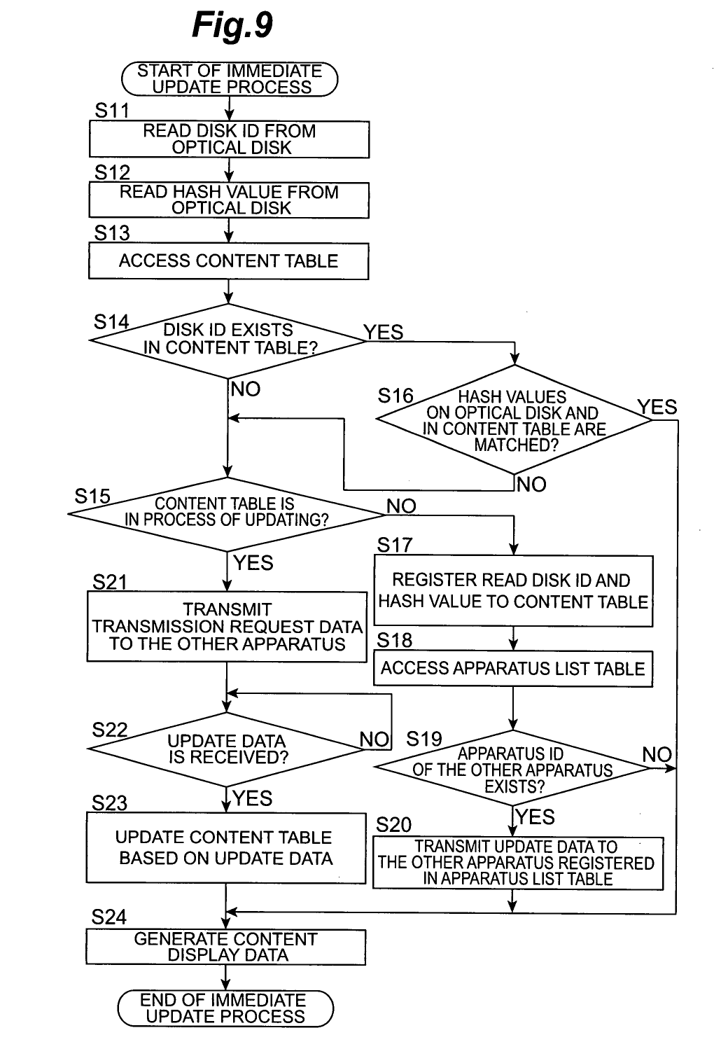

When the immediate update process is started, the MPU 201 proceeds to the block 11 as shown in FIG. 9. At the block 11, the optical disk drive 202 is activated according to an instruction of the MPU 201 to read the disk ID from the optical disk 110, and in the subsequent block 12, the optical disk drive 202 is activated to read the hash value and the digital data of the included contents from the optical disk 110. Next, the MPU 201 proceeds to the block 13, to access the content table 300. Subsequently, the MPU 201 proceeds to the block 14 and judges whether the read disk ID exists in the content table 300 or not. The MPU 201 proceeds to the block 16 when the read disk ID exists, but otherwise, it proceeds to the block 15. When the MPU 201 proceeds to the block 16, it judges whether the hash value of the optical disk 110 and the hash value of the content table 300 are matched or not. The MPU 201 proceeds to the block 24 when they are matched, but it proceeds to the block 15 when they are not matched. Consequently, when the disk ID and the hash value read from the optical disk 110 are registered in the content table 300, the content table 300 is not updated because the content included in the optical disk 110 is already reflected on the content table 300.

When the MPU 201 proceeds to the block 15, it performs an operation as a judging unit to judge whether the content table 300 is in process of updating or not. The MPU 201 proceeds to the block 17 when it is not judged to be in process of updating, but it proceeds to the block 21 when it is judged to be in process of updating. The MPU 201 newly registers the disk ID and the hash value read from the optical disk 110 by the optical disk drive 202 to the content table 300 when it proceeds to the block 17. At this time, the MPU 201 performs an operation as a content table updating unit, and updates the content table 300 so that the disk ID and the hash value read from the optical disk 110 are stored in association (contents specifying data area 300c is also updated).

Next, the MPU 201 proceeds to the block 18 to access the apparatus list table 310. Subsequently, the MPU 201 proceeds to the block 19 to judge whether the apparatus ID showing the other apparatus exists in the apparatus list table 310 or not. Here, the MPU 201 proceeds to the block 20 when it judges that the apparatus ID showing the other apparatus exists (apparatus ID is stored in the HDD), but otherwise, it proceeds to the block 24 when it does not judge as stated above. Besides, the MPU 201 obtains the destination data of the other apparatus from the destination area 310b of the apparatus list table 310 when it proceeds to the block 20. The MPU 201 performs an operation as an update data generation unit, and generates update data containing the disk ID and the hash value of the optical disk 110 read at the blocks 11, 12. Further, the MPU 201 performs an operation as an update data transmission control unit to transmit the generated update data to the network I/F device 206 (data transmission S1 shown in FIG. 13 is performed). Here, the update data is data to update the content table so that the disk ID and the hash value are stored in association.

The update data containing the disk ID and the hash value is transmitted at the block 20, then, the data stored in the content table are shared between the data recording/reproducing apparatuses 200, 220, and thereby, the correspondence of the optical disk 110 and the contents included therein can be managed by the data recording/reproducing apparatus 200 and the data recording/reproducing apparatus 220. Incidentally, when the process of the block 20 is executed, the MPU 201 judges whether the contents specifying data exist in plural in the content table 300 or not. When they exist in plural, content recording position specifying data to specify a recording position of the respective contents is also transmitted. The MPU 201 proceeds to the block 24 after it executes the block 20.

On the other hand, the MPU 201 performs an operation as a transmission request data transmission control unit when it proceeds from the block 15 to the block 21, and instructs the network I/F device 206 to transmit transmission request data to the other apparatus (data transmission S3 shown in FIG. 13 is performed). The transmission request data transmitted here is the data showing the transmission request of the update data containing the disk ID and the hash value read at the blocks 11, 12. Here, the data recording/reproducing apparatus 200 requests the transmission of the update data to the data recording/reproducing apparatus 220.

There is a case when it is impossible to update the content table 300 immediately because it is in process of updating when the disk ID and the hash value read at the blocks 11, 12 are to be registered to the content table 300. In such case, the transmission request data is transmitted to the data recording/reproducing apparatus 220, the update data containing the disk ID and the hash value to be registered is obtained from the data recording/reproducing apparatus 220, and thereby, the content table 300 is updated quickly to enable the content list 311 to be displayed quickly. In this case, even if the user ejects the optical disk 110 from the disk tray, the content table 300 is updated quickly and the content list 311 can be displayed quickly by using the update data if it exists at the other apparatus.

The MPU 201 performs an operation as an update control unit when it proceeds to the subsequent block 22, stands by until the network I/F device 206 receives the update data, and the MPU 201 proceeds to the block 23 when the update data is received (data reception S4 shown in FIG. 13 is performed). The MPU 201 performs an operation as a content table updating unit when it proceeds to the block 23 to update the content table 300 so that the disk ID and the hash value are associated based on the update data received by the network I/F device 206. The MPU 201 executes the block 23, and then, the MPU 201 proceeds to the block 24. Incidentally, the block 23 may be executed at a timing based on an advance designation of a user.

The MPU 201 performs an operation as a display data generation unit when it proceeds to the block 24, to generate the content display data with reference to the content table 300. This content display data is data to display the content table 300 on the image/sound output device 208 by editing into a format of the content list 311. The MPU 201 executes this block 24 subsequent to the block 20, 23, to thereby control the content display data to be generated based on the updated content table 300, and therefore, the MPU 201 has a function as a display data generation control unit. The MPU 201 executes the block 24, and then, terminates the immediate update process.

Next, returning to FIG. 8, the MPU 201 proceeds to the block 6 to execute the later update process. This later update process is a process in which the user once ejects the optical disk 110 including the contents from the disk tray, the content list 311 is displayed immediately based on the update data received from the other apparatus, and thereafter, the content table 300 is updated based on the received update data (the update of the content table 300 is performed at a later-described transmission/reception checking process).

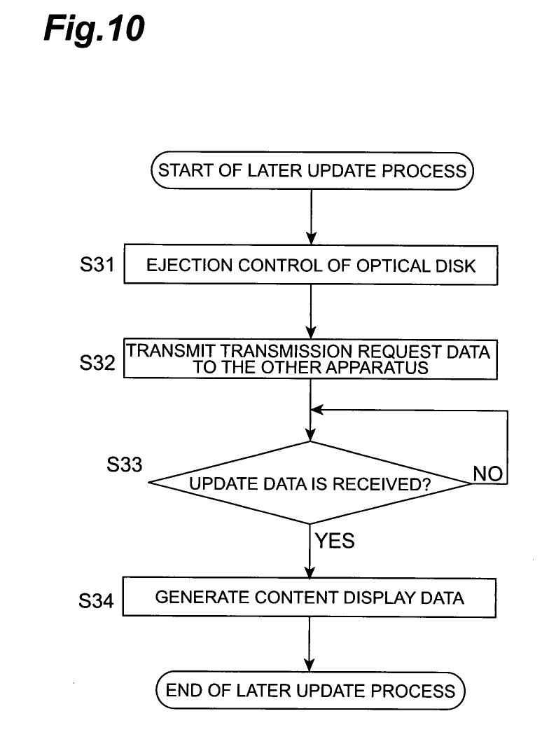

When the later update process is started, the MPU 201 proceeds to the block 31 as shown in FIG. 10. At the block 31, the MPU 201 performs an ejection control of a disk, and instructs the optical disk drive 202 to open the disk tray. After the optical disk 110 is ejected, the MPU 201 proceeds to the block 32 to transmit the transmission request data. Here, the transmission request data requesting to transmit the data stored in the content table of the data recording/reproducing apparatus 220 is transmitted (data transmission S5 shown in FIG. 13 is performed). After that, the MPU 201 proceeds to the block 33, performs an operation as the display data generation control unit, and stands by until the update data is received (data reception S6 shown in FIG. 13 is performed). The MPU 201 proceeds to the block 34, performs an operation as the display data generation unit, generates the content display data based on the received update data, and thereafter, terminates the later update process.

Further, returning to FIG. 8, the MPU 201 proceeds to the block 7 to execute the other apparatus priority process. This other apparatus priority process is a process in which the data recording/reproducing apparatus 200 displays the content list 311 using the content table stored on the other apparatus by priority than the content table 300 stored on the nonvolatile memory device 203.

This other apparatus priority mode assumes the cases as shown in the following. Namely, for example, it is the case when the data recording/reproducing apparatus 220 is conventionally used for recording and reproducing the contents, but the data recording/reproducing apparatus 200 is just newly purchased and the content table 300 is not generated yet. Besides, it is a case when the data recording/reproducing apparatus 200 is also conventionally used for recording and reproducing the contents but it is preferable to use the content table of the other apparatus by priority if the content table is stored on the apparatus other than the data recording/reproducing apparatus 200.

In the data recording/reproducing apparatus 200, the other apparatus priority mode is provided to correspond to the cases as stated above in addition to the immediate update mode and the later update mode. In this other apparatus priority mode, the update data transmitted from the other apparatus is used by priority than the disk ID and the hash value read from the optical disk 110, to thereby display the content list 311 quickly.

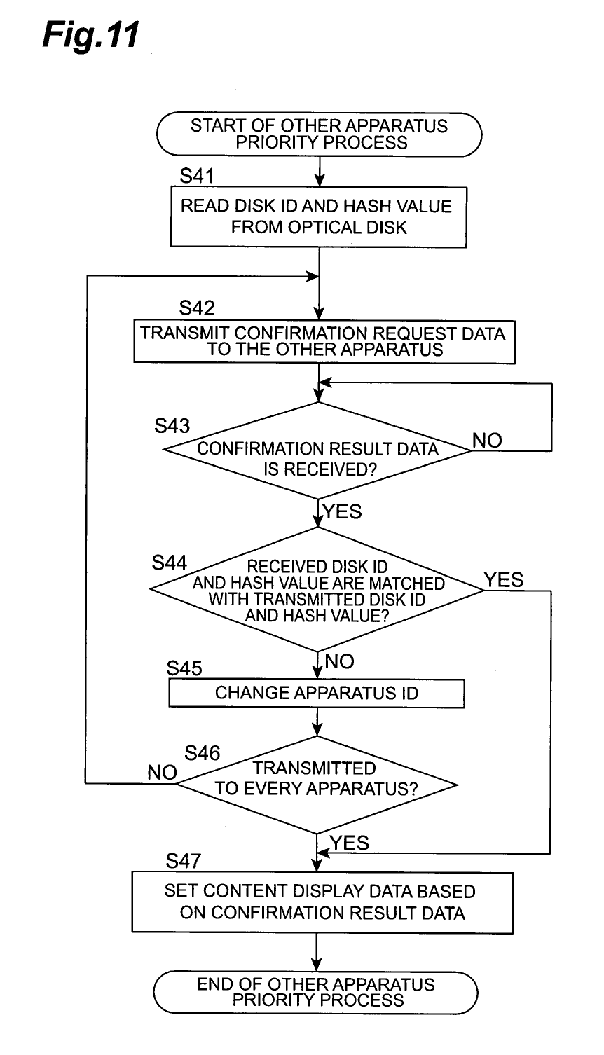

When the other apparatus priority process is started, the MPU 201 proceeds to the block 41 as shown in FIG. 11. At the block 41, the MPU 201 activates the optical disk drive 202 to read the disk ID and the hash value from the optical disk 110. Next, the MPU 201 proceeds to the block 42, performs an operation as the transmission request data transmission control unit, and instructs the network I/F device 206 to transmit confirmation request data to the other apparatus (data transmission S7 shown in FIG. 13 is performed). The confirmation request data transmitted here is the transmission request data requesting a transmission of later-described confirmation result data to the other apparatus (inquire of the other apparatus).

The MPU 201 proceeds to the block 43, stands by until the network I/F device 206 receives the later-described confirmation result data (until the data reception S8 shown in FIG. 13 is performed). The MPU 201 proceeds to the subsequent block 44, judges whether the disk ID and the hash value based on the confirmation request data, and the disk ID and the hash value based on the confirmation result data are matched or not. When they are matched, the MPU 201 proceeds to the block 47, but it proceeds to the block 45 if they are not matched. Besides, when the MPU 201 proceeds to the block 45, it changes the apparatus ID, then proceeds to the subsequent block 46, and judges whether the confirmation request data are transmitted to every apparatus or not.

Here, when it is judged that the confirmation request data are transmitted to every device, the MPU 201 proceeds to the block 47, but otherwise, it returns to the block 42. Herewith, the MPU 201 controls so that the confirmation request data are to be transmitted to every device registered in the apparatus list table 310 until the disk ID and the hash value based on the confirmation request data are received. Further, when the MPU 201 proceeds to the block 47, it performs an operation as a content display data generation unit, and generates content display data based on the confirmation result data received at the block 43.

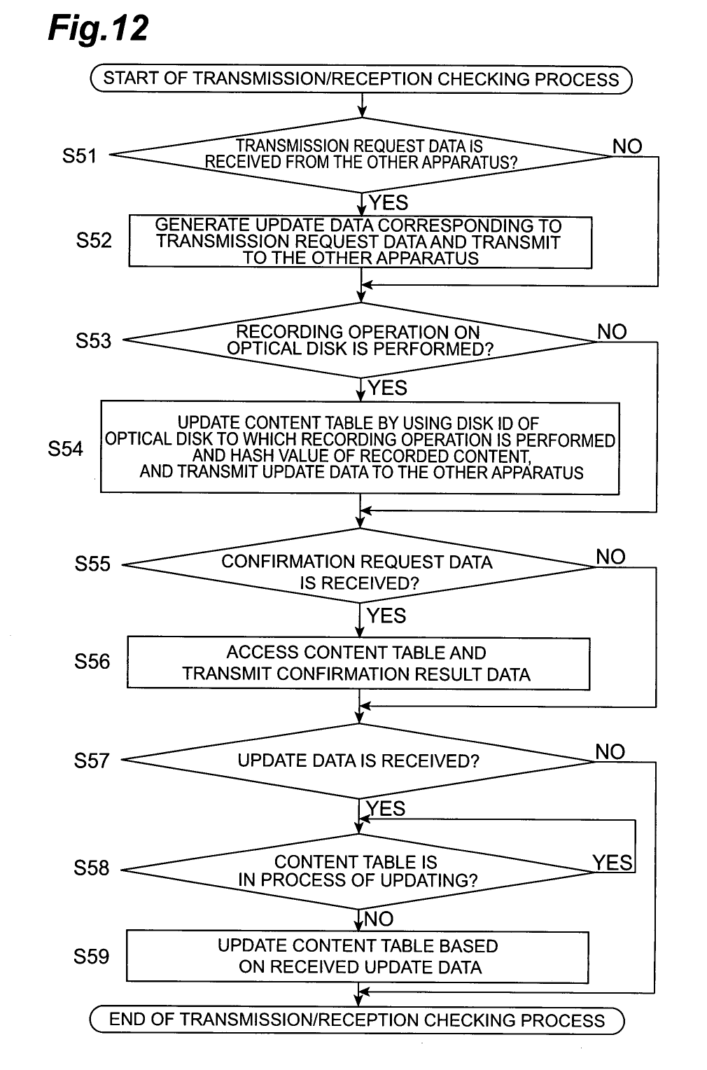

Meantime, the MPU 201 executes the transmission/reception checking process shown in FIG. 12 by every predetermined time (for example, 1 ms). The MPU 201 starts the transmission/reception checking process, then proceeds to the block 51, and judges whether the transmission request data is received from the other apparatus or not. When it is received, the MPU 201 proceeds to the block 52 to generate the update data corresponding to the transmission request data. The MPU 201 performs an operation as the update data generation unit when it generates the update data. In this case, the MPU 201 generates the update data by reading the data corresponding to the transmission request data from the content table 300. Besides, the MPU 201 performs an operation as the update data transmission control unit, and controls so that the network I/F device 206 transmits the generated update data to the other apparatus.

Next, the MPU 201 proceeds to the block 53, and judges whether a recording operation to record the digital data to the optical disk 110 is performed by the optical disk drive 202 or not. When the recording operation is performed, the MPU 201 proceeds to the block 54, but otherwise, it proceeds to the block 55. When the MPU 201 proceeds to the block 54, it performs an operation as the update data generation unit, and generates the update data as stated bellow.

Namely, the MPU 201 updates the content table 300 by using the disk ID of the optical disk 110 to which the recording operation is performed and the hash value of the included contents, and generates the update data containing the disk ID and the hash value. Besides, the MPU 201 transmits the generated update data to the other apparatus by the network I/F device 206 (data transmission S2 shown in FIG. 13 is performed). In this case, the update data may be transmitted by one transmission process, or it may be transmitted by dividing into plural times.

Besides, the MPU 201 proceeds to the block 55, and then, judges whether the above-stated confirmation request data is received via the network I/F device 206 or not. When it is judged that the confirmation request data is received, the MPU 201 proceeds to the block 56, but otherwise, it proceeds to the block 57. When the process is advanced to the block 56, the MPU 201 accesses the content table 300, confirms whether the disk ID and the hash value corresponding to the received confirmation request data exist in the content table 300 or not, and transmits the confirmation result data showing the confirmation result thereof via the network I/F device 206. Incidentally, when the disk ID and the hash value corresponding to the received confirmation request data exist in the content table 300, the data corresponding to the disk ID and the hash value is read from the content table 300, to thereby generate the confirmation result data.

Besides, when the process is advanced to the block 57, the MPU 201 judges whether the update data is received via the network I/F device 206 or not. Here, the MPU 201 performs an operation as the update control unit, and it proceeds to the block 58 when it is judged that the update data is received, but otherwise, terminates the transmission/reception checking process. The MPU 201 proceeds to the block 58, stands by until an update is completed when the content table 300 is in process of updating as same as the block 44. The MPU 201 proceeds to the block 59 when the update is completed, and performs an operation as the content table updating unit. Namely, the MPU 201 updates the content table 300 so that the disk ID and the hash value are associated based on the update data received by the network I/F device 206. The MPU 201 executes the block 59, then terminates the transmission/reception checking process.

Among these blocks 51 to 59, the blocks 51, 52 correspond to the case when the transmission request data is received from the other apparatus. The MPU 201 executes the blocks 51, 52, and thereby, it becomes possible to share the content table while securing a synchronization between the data recording/reproducing apparatus 200 and the data recording/reproducing apparatus 220, and to manage the correspondence of the optical disk 110 and the contents included therein by the data recording/reproducing apparatus 200 and the data recording/reproducing apparatus 220.

Besides, the block 53, 54 have meanings as stated bellow. Namely, when the recording operation of the digital data to the optical disk 110 is performed by the optical disk drive 202, namely, a rewrite of the optical disk 110 is performed, the update data based on the disk ID of the optical disk 110 being an object of the rewriting and the hash value of the recorded contents is transmitted to the other apparatus. At the data recording/reproducing apparatus 220, contents after the rewrite is therefore reflected to the content table even when the rewrite of the optical disk 110 is performed at the data recording/reproducing apparatus 200. Consequently, in the data presentation system 100, the content table is shared by the data recording/reproducing apparatus 200 and the data recording/reproducing apparatus 220 while securing the synchronization thereof at both of the apparatuses, and it is possible to display the content list 311 with the contents after the rewrite.

Further, the block 55, 56 correspond to the case when the confirmation request data is received from the other apparatus.

The processes at the blocks 57 to 59 correspond to the case when the content table 300 is updated based on the update data transmitted from the other apparatus with corresponding to the transmission request data transmitted at the block 32 in the later update process.

Besides, for example, there is a case when a recording of contents on an optical disk is performed and a rewrite of data is performed by the data recording/reproducing apparatus 220, but a disk ID of the optical disk and a hash value of the included contents are not registered to the content table 300 of the data recording/reproducing apparatus 200 yet (the case when the disk ID and the hash value are not shared).

Further, when the data recording/reproducing apparatus 200 is a reproducing only apparatus not having a recording function from the beginning, only the apparatus other than the apparatus in which the recording of the contents is performed can register the disk ID and the hash value to the content table, and can display the content list. When the data recording/reproducing apparatus 200 is a newly purchased apparatus, the content list cannot be displayed because no data exist in the content table.

In such a case, the user can select the above-stated later update mode or the other apparatus priority mode. Besides, the processes at the blocks 57 to 59 are executed regularly, and therefore, the content table 300 is to be updated after the content list 311 is displayed based on the received update data in the data recording/reproducing apparatus 200. Herewith, the content table can be shared while securing the synchronization thereof constantly as well as the user can search the included contents quickly.

As it is obvious from the above, in the data presentation system 100 according to the present embodiment, it is possible to search the contents by using either of the data recording/reproducing apparatuses 200, 220, and the user can search the included contents quickly.

### Second Embodiment

It is conceivable that a power of either one of the data recording/reproducing apparatuses 200, 220 composing the data presentation system 100 is not turned on. In such a case, for example, when the power of the data recording/reproducing apparatus 220 is not turned on, the case is assumed that it is impossible to display the content list 311 with the most recent matters because the update data cannot be obtained from the data recording/reproducing apparatus 220 when the user selects the above-stated later update mode or other apparatus priority mode.

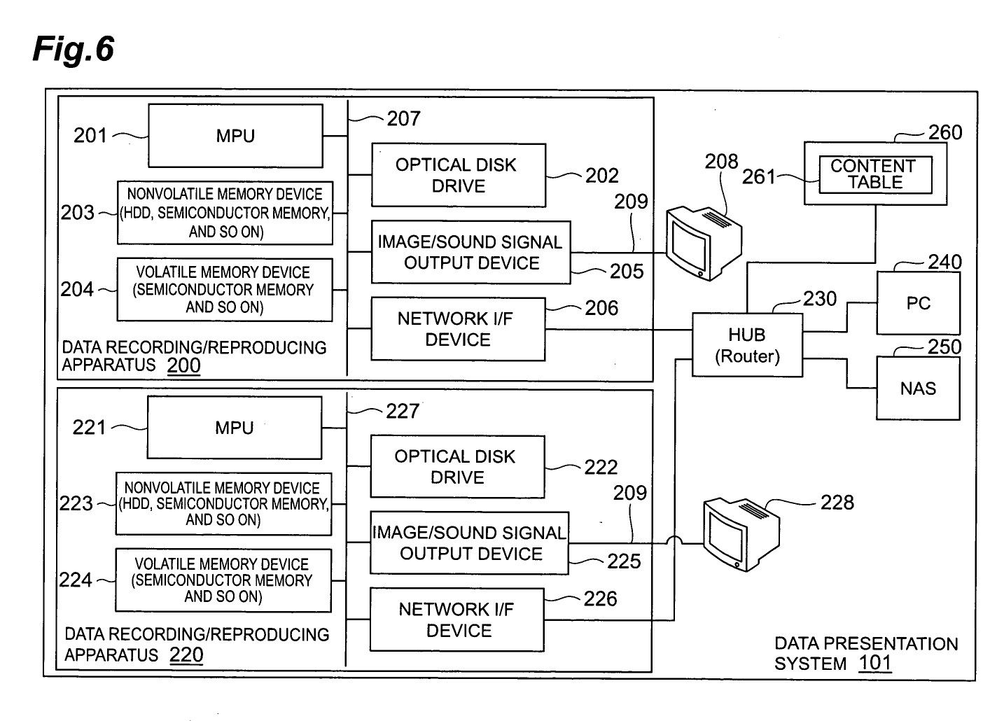

It is preferable to configure a data presentation system 101 as shown in FIG. 6 to correspond to such a case. In this data presentation system 101, points that a data management server (home server or external server) 260 is connected to the HUB 230, and an image/sound output device 228 is connected to the data recording/reproducing apparatus 220 are different compared to the data presentation system 100, but they are common in other points.

The data management server 260 has a nonvolatile memory device composed of a nonvolatile semiconductor memory such as an HDD and a flash memory, and a content table 261 having a common constitution with the content table 300 and a not-shown apparatus list table having a common constitution with the apparatus list table 310 are provided at the nonvolatile memory device. Incidentally, in the data management server 260, a volatile memory device may be equipped instead of the above-stated nonvolatile memory device, and the volatile memory device may be used as same as the nonvolatile memory device by turning on the power thereof constantly.

The data management server 260 executes the same processes as the blocks 51, 52, and 55 to 59 in the above-stated transmission/reception checking process. It becomes possible to manage the content table in the most recent state by the data management server 260, and the content table can be shared by the data recording/reproducing apparatuses 200, 220 and the data management server 260.

Further, the data management server 260 has a unit to judge whether the powers of the data recording/reproducing apparatuses 200, 220 composing the data presentation system 101 are turned on or not. The update data to update the content table 300 and the apparatus list table 310 into the most recent state may be transmitted at the time when the powers thereof are turned on. The content table 300 and the apparatus list table 310 may be updated into the most recent state by setting as stated above.

Besides, the function of the data management server 260 as stated above may be provided at the PC 240 or the NAS 250.

### MODIFIED EXAMPLE

In the above-stated respective embodiments, the content table containing the disk ID and the hash value is shared by plural devices to thereby multiply manage it by the plural devices composing the data presentation systems 100, 101. In addition, the content table may be provided only at any one of devices composing the data presentation systems 100, 101 (for example, the server) to thereby manage the disk ID and the hash value uniformly.

At both data presentation systems 100, 101, the PC 240 and the NAS 250 are connected to the data recording/reproducing apparatuses 200, 220. The data presentation system according to the present invention is applied to a case when neither the PC 240 nor the NAS 250 are connected to the data recording/reproducing apparatuses 200, 220, and to a case when either one of them is connected to the data recording/reproducing apparatuses 200, 220.

In the process at the block 5, the reproduction preparation process may be executed before the execution of the above-stated processes. Besides, the timing to execute the process of the block 5 may be changed based on an advance designation of the user.

In the above-stated embodiments, the data recording/reproducing apparatuses 200, 220 having both the reading device and the recording device are described as an example, but the present invention is also applied to a data reproducing apparatus not having the recording device. Besides, the data recording/reproducing apparatuses 200, 220 have the HDDs, but the present invention is also applied to a data reproducing apparatus not having the HDD.

Further, in the data recording/reproducing apparatus 200, both the nonvolatile memory device 203 and the volatile memory device 204 may be nonvolatile memory devices or volatile memory devices (it is the same as for the nonvolatile memory device 223 and the volatile memory device 224 of the data recording/reproducing apparatus 220). When they are made to be the volatile memory devices, it is preferable to turn on the powers thereof constantly.

In the above-stated embodiment, the hash value is generated as data specific to the content uniquely showing the included content (generation method 1). This hash value may be the one that the included content is identifiable, and one hash value may be generated for a whole of plural contents (generation method 2). Besides, one, two or more hash value(s) may be generated by combining the generation methods 1, 2 (generation method 3).

Data showing an approval or non-approval (approval flag data) of the transmission request may be included in the update data transmitted from the data recording/reproducing apparatus 200 to the data recording/reproducing apparatus 220 at the block 20 and so on, so that the data recording/reproducing apparatus 220 can judge whether the update data is to be transmitted or not in accordance with the transmission request based on the approval flag data.

As it is described above, a data reproducing apparatus capable of searching contents by using any one of plural apparatuses, in which a user can search the included contents quickly, a data presentation method using the data reproducing apparatus, and a data presentation system having the data reproducing apparatus can be obtained according to the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A data reproducing apparatus having a reading device reading data recorded on a recording medium and a communication device performing a data transmission/reception, comprising:
a display data generation unit generating content display data to display a content table in which a media identification code specific to the recording medium and a content code identifiable a content included in the recording medium are associated;
a transmission request data transmission control unit controlling the communication device to transmit transmission request data showing a transmission request relating to the media identification code and the content code to external; and
a display data generation control unit controlling the content display data to be generated based on received data received by the communication device with corresponding to the transmission request data transmitted by the communication device.

2. The data reproducing apparatus according to claim 1, further comprising:
a content table updating unit updating the content table so that the media identification code read by the reading device and the content code are stored in association, and the media identification code received by the communication device and the content code are stored in association, and
wherein said display data generation control unit controls said display data generation unit to generate the content display data based on the content table updated by said content table updating unit.

3. The data reproducing apparatus according to claim 2, further comprising:
an update control unit controlling said content table updating unit to update the content table when the communication device transmits the transmission request data showing the transmission request of update data to update the content table to external, and the communication device receives the update data.

4. The data reproducing apparatus according to claim 2, further comprising:
an update data generation unit generating the update data corresponding to the received transmission request data when the transmission request data showing the transmission request of the update data to update the content table is received from external by the communication device; and
an update data transmission control unit controlling the communication device to transmit the update data generated by said update data generation unit to external.

5. The data reproducing apparatus according to claim 3, further comprising:
an update data generation unit generating the update data corresponding to the received transmission request data when the transmission request data showing the transmission request of the update data to update the content table is received from external by the communication device; and
an update data transmission control unit controlling the communication device to transmit the update data generated by said update data generation unit to external.

6. The data reproducing apparatus according to claim 4, further comprising:
a content table storing device in which the content table is stored; and
an apparatus identification code storing device in which apparatus identification codes specific to the data reproducing apparatuses are stored, and
wherein said update data transmission control unit controls the update data to be transmitted to the other data reproducing apparatus when the apparatus identification code showing the other data reproducing apparatus is stored in said apparatus identification code storing device.

7. The data reproducing apparatus according to claim 5, further comprising:
a content table storing device in which the content table is stored; and
an apparatus identification code storing device in which apparatus identification codes specific to the data reproducing apparatuses are stored, and
wherein said update data transmission control unit controls the update data to be transmitted to the other data reproducing apparatus when the apparatus identification code showing the other data reproducing apparatus is stored in said apparatus identification code storing device.

8. The data reproducing apparatus according to claim 4, further comprising:
a recording device recording data on the recording medium, and
wherein said update data generation unit generates the update data by using the media identification code specific to the recording medium to which a recording operation is performed and the content code identifiable the included content, when the recording operation recording the content on the recording medium is performed by said recording device.

9. The data reproducing apparatus according to claim 6, further comprising:
a recording device recording data on the recording medium, and
wherein said update data generation unit generates the update data by using the media identification code specific to the recording medium to which a recording operation is performed and the content code identifiable the included content, when the recording operation recording the content on the recording medium is performed by said recording device.

10. The data reproducing apparatus according to claim 2, further comprising:
a judging unit judging whether the content table is in process of updating by said content table updating unit or not, and
wherein said update control unit controls the communication device to transmit the transmission request data to external when it is judged that the content table is in process of updating by said judging unit.

11. The data reproducing apparatus according to claim 3, further comprising:
a judging unit judging whether the content table is in process of updating by said content table updating unit or not, and
wherein said update control unit controls the communication device to transmit the transmission request data to external when it is judged that the content table is in process of updating by said judging unit.

12. The data reproducing apparatus according to claim 4, further comprising:
a judging unit judging whether the content table is in process of updating by said content table updating unit or not, and
wherein said update control unit controls the communication device to transmit the transmission request data to external when it is judged that the content table is in process of updating by said judging unit.

13. The data reproducing apparatus according to claim 6, further comprising:
a judging unit judging whether the content table is in process of updating by said content table updating unit or not, and
wherein said update control unit controls the communication device to transmit the transmission request data to external when it is judged that the content table is in process of updating by said judging unit.

14. The data reproducing apparatus according to claim 8, further comprising:
a judging unit judging whether the content table is in process of updating by said content table updating unit or not, and
wherein said update control unit controls the communication device to transmit the transmission request data to external when it is judged that the content table is in process of updating by said judging unit.

15. A data presentation method using data reproducing apparatuses including a reading device reading data recorded on a recording medium, and a communication device performing a data transmission/reception, comprising the steps of:
generating content display data to display a content table by the data reproducing apparatus, in which a media identification code specific to the recording medium and a content code identifiable a content included in the recording medium are associated;
controlling the communication device to transmit transmission request data showing a transmission request relating to the media identification code and the content code to external; and
controlling the content display data to be generated based on received data received by the communication device with corresponding to the transmission request data transmitted by the communication device.

16. The data presentation method according to claim 15,
wherein the content table is updated so that the media identification code read by the reading device and the content code are stored in association, and the media identification code received by the communication device and the content code are stored in association, and
controlling the content display data to be generated based on the updated content table.

17. A data presentation system having a first and a second data reproducing apparatuses including a reading device reading data recorded on a recording medium, and a communication device performing a data transmission/reception,
wherein at least either one of the first or the second data reproducing apparatus includes:
a display data generation unit generating content display data to display a content table in which a media identification code specific to the recording medium and a content code identifiable the content included in the recording medium are associated;
a transmission request data transmission control unit controlling the communication device to transmit transmission request data showing a transmission request relating to the media identification code and the content code to external; and
a display data generation control unit controlling the content display data to be generated based on received data received by the communication device with corresponding to the transmission request data transmitted by the communication device.

18. The data presentation system according to claim 17, further comprising:
a data management server, including:
a content table updating unit updating the content table so that the media identification code read by the reading device and the content code are stored in association, and the media identification code received by the communication device and the content code are stored in association;
an update data generation unit generating update data corresponding to the received transmission request data when the transmission request data showing the transmission request of the update data to update the content table is received from the first or the second data reproducing apparatus; and
an update data transmission control unit controlling the update data generated by the update data generation unit to be transmitted to the first or the second data reproducing apparatus.
